(19) United States
(12) Patent Application Publication
(10) Pub. No.: US 2005/0262153 A1
(43) Pub. Date: Nov. 24, 2005

(54) Data reproducing apparatus

(76) Inventor: Masuyuki Takeda, Tokyo (JP)

Correspondence Address: BIRCH STEWART KOLASCH & BIRCH, PO BOX 747, FALLS CHURCH, VA, 22040-0747, US

(21) Appl. No.: 10/635,029

(22) Filed: Aug. 6, 2003

(30) Foreign Application Priority Data
Nov. 21, 2002 (JP) 2002-338172

(51) Int. Cl. G06F 12/00

(52) U.S. Cl. 707/200

(57) ABSTRACT

A data reproducing apparatus starts replaying a disk from a logical sector number “2180h”, which is searched for by a partition acquiring unit 13, and acquires the logical block numbers “A8h” and “ABh” of file entries (i.e., “VR_MANGAR.IFO” and “VR_MOVIE.VRO” file entries). Therefore, the data reproducing apparatus can identify the position of a file without changing the standard to which the file system of the disk conforms even if there occurs a data loss in the management information about the file.

### BACKGROUND OF THE INVENTION

1. Field of the Invention

The present invention relates to a data reproducing apparatus that identifies the position of a file recorded on a disk with reference to management information about the file, and starts reproducing data recorded on the disk from the file position.

2. Description of Related Art

In order to identify the position of a file recorded on a disk even when there is a data loss in management information (for example, a logical volume descriptor) about the file, a prior art data reproducing apparatus redundantly records additional management information about the file recorded on the disk (for example, refer to Japanese patent application publication No. 2001-36841 (see FIG. 1)).

A problem with the prior art data reproducing apparatus constructed as mentioned above is that while even if there occurs a data loss in a piece of management information, the data reproducing apparatus can identify the position of a corresponding file with reference to another piece of management information, the standard to which the file system conforms has be changed because the redundant management information about the file needs to be recorded. A further problem is that only a part of the partition is assigned to a sparing area that is a redundant preliminary data region defined by the file system standard, and therefore the prior art data reproducing apparatus cannot deal with a data loss that occurs outside the partition.

### SUMMARY OF THE INVENTION

The present invention is proposed to solve the above-mentioned problems, and it is therefore an object of the present invention to provide a data reproducing apparatus that can identify the position of a file recorded on a disk even if a data loss occurs in the management information about the file without changing the standard to which the file system of the disk conforms.

In accordance with the present invention, there is provided a data reproducing apparatus including a file entry acquiring unit for starting replaying a disk from a predetermined logical sector number so as to acquire a logical block number of a file entry, and a file position identifying unit for acquiring a logical block number indicating a position of a file from the logical block number acquired by the file entry acquiring unit and from a logical sector number acquired by a partition acquiring unit, and for identifying a logical sector number indicating the position of the file from the logical block number acquired thereby and from the logical sector number acquired by the partition acquiring unit.

Therefore, the data reproducing apparatus can identify the position of the file without changing the standard to which the file system of the disk conforms even if there occurs a data loss in the management information about the file.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a data reproducing apparatus in accordance with embodiment 1 of the present invention;

FIG. 2 is a block diagram showing a processing function of a control unit of the data reproducing apparatus in accordance with embodiment 1 of the present invention;

FIG. 3 is an explanatory drawing showing contents recorded on a disk and order in which the contents are reproduced;

FIG. 4 is a flow chart showing processes performed by the control unit of the data reproducing apparatus in accordance with this embodiment 1;

FIG. 5 is a flow chart showing a process A performed by the control unit;

FIG. 6 is a flow chart showing a process B performed by the control unit;

FIG. 7 is a flow chart showing a process C performed by the control unit;

FIG. 8 is a flow chart showing a process D performed by the control unit;

FIGS. 9 and 10 are flow charts showing a process E performed by the control unit;

FIG. 11 is a flow chart showing a process F performed by the control unit;

FIG. 12 is a flow chart showing a process G performed by the control unit;

FIG. 13 is a flow chart showing a process H performed by the control unit;

FIGS. 14 and 15 are flow charts showing a process I performed by the control unit;

FIG. 16 is a flow chart showing a process J performed by the control unit;

FIG. 17 is a flow chart showing a process K performed by the control unit;

FIG. 18 is a block diagram showing a processing function of a control unit of a data reproducing apparatus in accordance with embodiment 2 of the present invention;

FIG. 19 is a flow chart showing processes performed by the control unit of the data reproducing apparatus in accordance with this embodiment 2;

FIG. 20 is a flow chart showing a process L performed by the control unit;

FIG. 21 is a block diagram showing a processing function of a control unit of a data reproducing apparatus in accordance with embodiment 3 of the present invention;

FIG. 22 is a flow chart showing processes performed by the control unit of the data reproducing apparatus in accordance with this embodiment 3;

FIG. 23 is a flow chart showing a process M performed by the control unit; and

FIG. 24 is a flow chart showing a process N performed by the control unit.

### DETAILED DESCRIPTION OF THE PREFERRED EMBODIMENTS

The invention will now be described with reference to the accompanying drawings.

### Embodiment 1

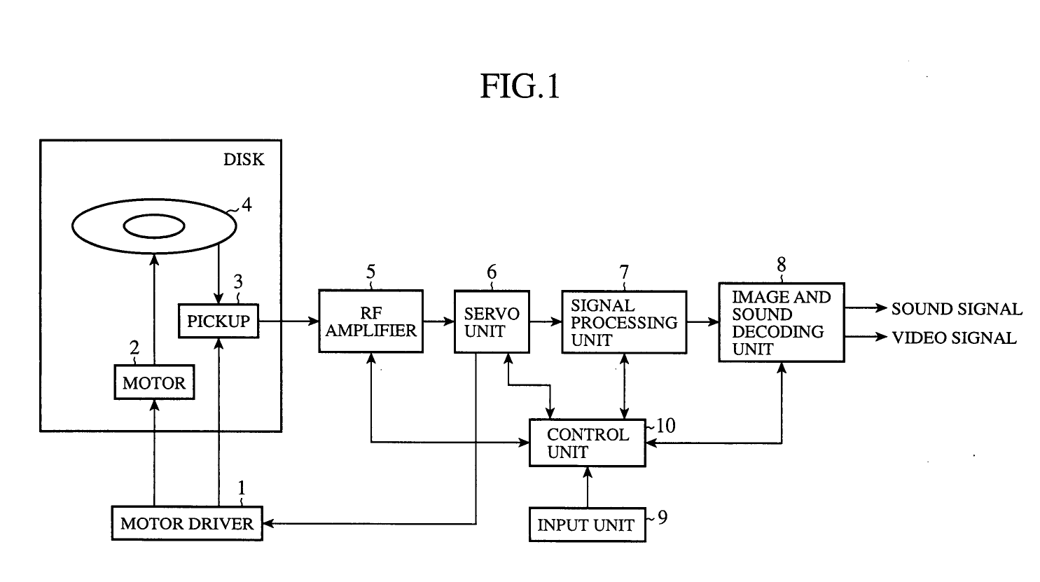

FIG. 1 is a block diagram showing the structure of a data reproducing apparatus in accordance with embodiment 1 of the present invention. In the figure, a motor driver 1 controls an electric current to be furnished to a motor 2 and a pickup 3 according to a control signal output from a servo unit 6, and the motor 2 rotates a disk 4 when receiving the electric current furnished thereto from the motor driver 1. When receiving the electric current furnished thereto from the motor driver 1, the pickup 3 drives an actuator, reads a pattern of pits recorded on the disk 4, and delivers a high frequency signal according to the pit pattern.

An RF amplifier 5 amplifies the high frequency signal delivered from the pickup 3, and the servo unit 6 generates a control signal to be given to the motor 2 and the pickup 3 according to the amplified high frequency signal. A signal processing unit 7 performs various processes, such as an error correction process, on the amplified high frequency signal, and extracts digital data from the processed signal. An image and sound decoding unit 8 decodes the digital data extracted by the signal processing unit 7 into a video signal and a sound signal. An input circuit 9 accepts an operation signal input to the data reproducing apparatus, and a control unit 10 controls the operation of the data reproducing apparatus according to the operation signal accepted by the input circuit 9.

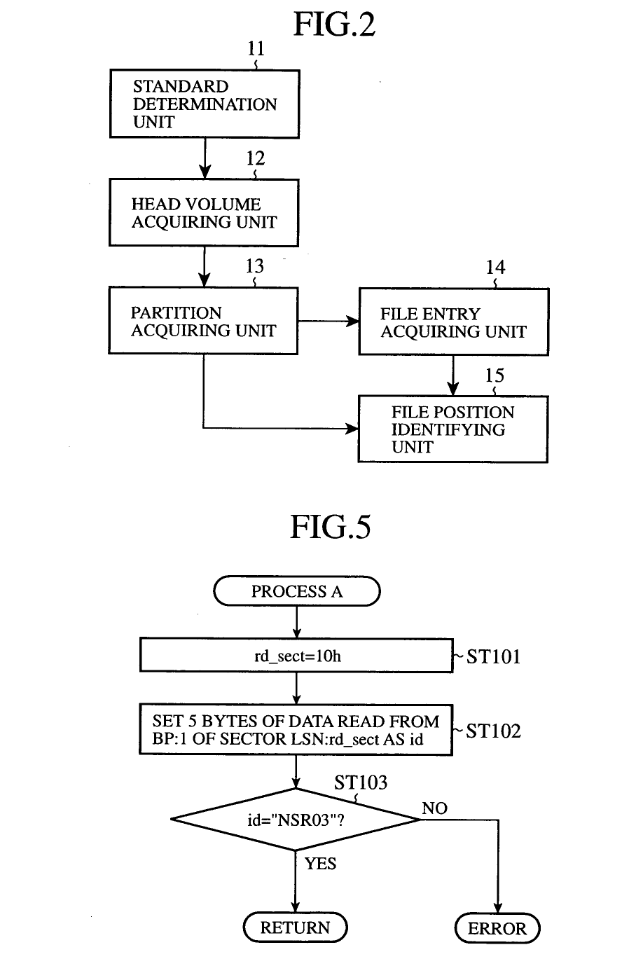

FIG. 2 is a block diagram showing the structure of a processing function of the control unit 10. In general, the control unit 10 consists of a microcomputer, and executes software to perform the various processes. In the figure, a standard determination unit 11 reads a character string recorded at a predetermined location of the disk so as to determine the standard to which the file system of the disk conforms. When the standard determination unit 11 determines that the file system conforms to “ECMA167”, a header volume acquiring unit 12 acquires a logical sector number “20h” of a header volume descriptor from an anchor volume descriptor that exists at a logical sector number “100h” (h shows a hexadecimal number). A partition acquiring unit 13 starts replaying the disk from the logical sector number “20h” acquired by the header volume acquiring unit 12 so as to search for a partition descriptor, and acquires a logical sector number “2180h” indicating a starting location of a partition from the partition descriptor. A partition acquiring means is provided with the header volume acquiring unit 12 and the partition acquiring unit 13.

A file entry acquiring unit 14 performs a reproduction of the disk and searches for a logical volume descriptor. When a logical block number “90h” of a first file set descriptor is not acquired from the logical volume descriptor due to a data loss, the file entry acquiring unit 14 starts replaying the disk from the logical sector number “2180h” acquired by the partition acquiring unit 13 so as to search for logical block numbers “A8h” and “ABh” of file entries (i.e., “VR_MANGAR.IFO” and “VR_MOVIE.VRO” file entries). The file entry acquiring unit 14 constitutes a file entry acquiring means.

A file position identifying unit 15 acquires logical block numbers “600h” and “11D2h” indicating the positions of files from the file entries which respectively exist at the logical block numbers “A8h” and “ABh” acquired by the file entry acquiring unit 14, and identifies logical sector numbers “2780h” and “3352h” indicating the file positions from the logical block numbers “600h” and “11D2h” and the logical sector number “2180h” acquired by the partition acquiring unit 13. The file position identifying unit 15 constitutes a file position identifying means.

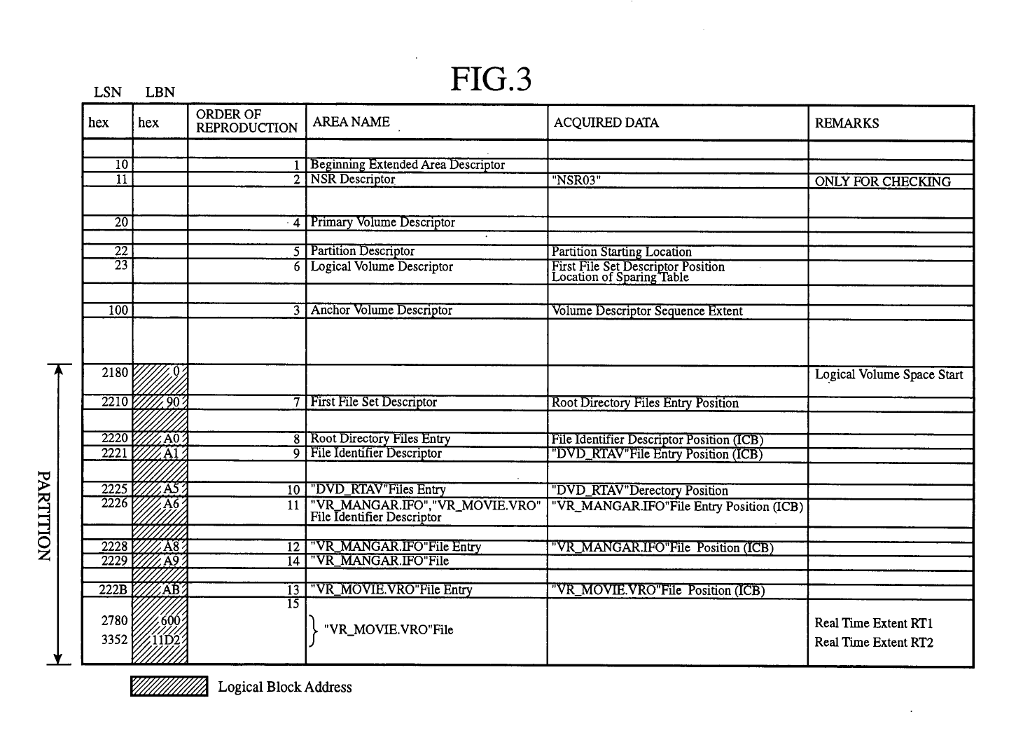

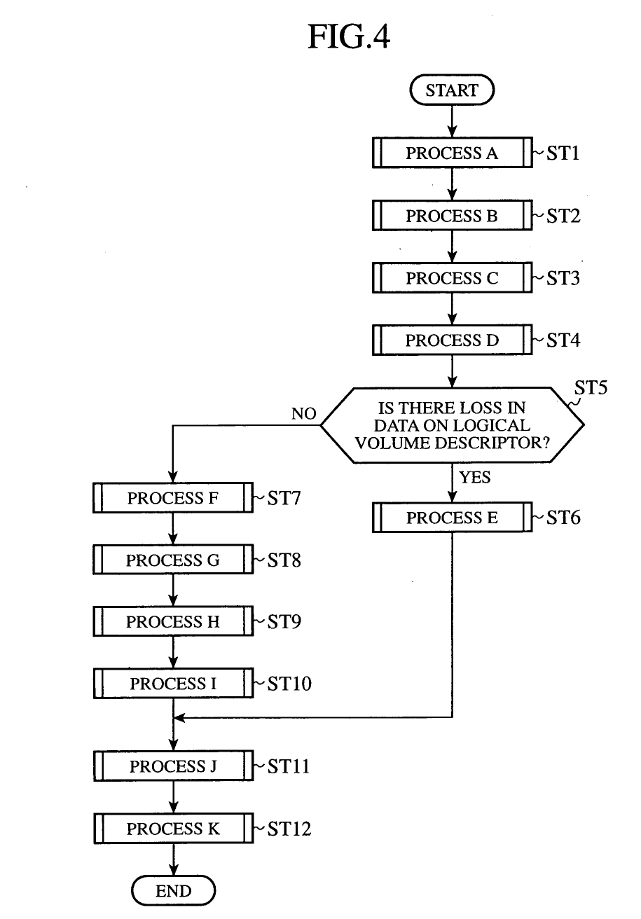

FIG. 3 is an explanatory drawing showing the contents recorded on the disk and order in which the contents are reproduced. In the figure, LSN denotes logical sector numbers given to locations within the disk including a recording start location through a recording end location, and LSN0 corresponds to a physical address PSN of 30000h. In other words, LSN=PSN−30000h. In this example, each sector has 2048 bytes. LBN denotes logical block numbers virtually given to locations within the partition including a starting location through an ending location, in which data to be reproduced and management information about the data are recorded. FIGS. 4 to 17 are flow charts showing processes performed by the control unit 10 of the data reproducing apparatus in accordance with embodiment 1 of the present invention.

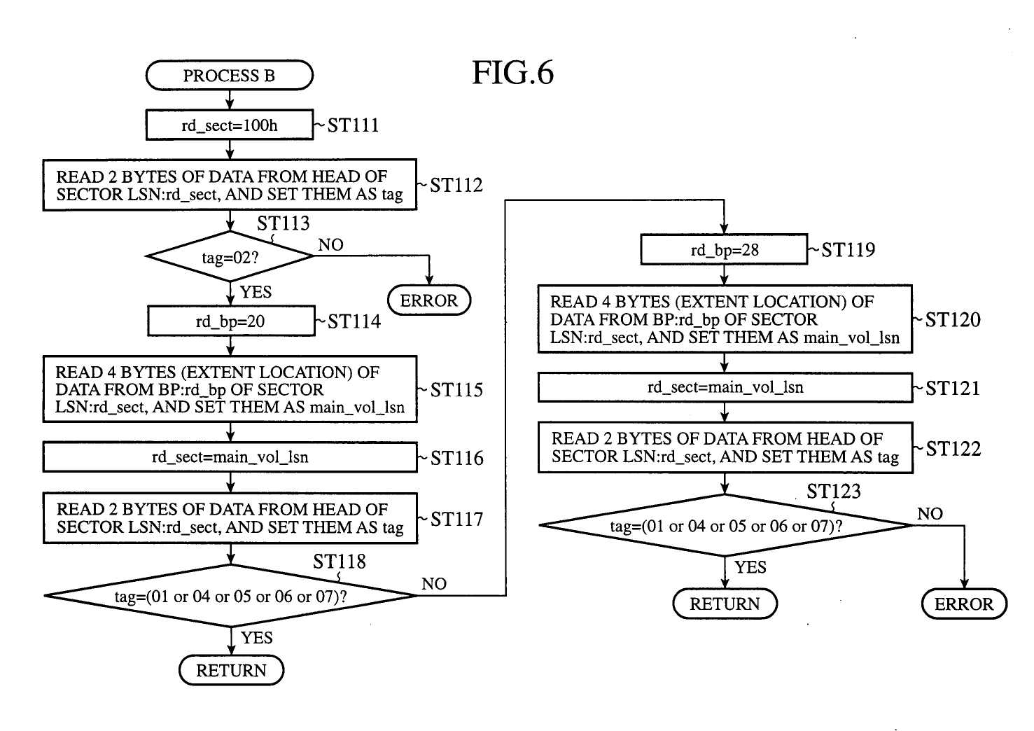

Next, a description will be made as to the operation of the control unit 10 of the data reproducing apparatus in accordance with embodiment 1 of the present invention. First of all, the standard determination unit 11 of the control unit 10 carries out a process A (in step ST1) so as to read a character string that is recorded at a logical sector number “10h”, and to check to see whether or not the character string is “NSR03”. When the character string is “NSR03”, the standard determination unit 11 recognizes that the file system conforms to the “ECMA167” standard, whereas the standard determination unit 11 assumes that an error has occurred and ends the process A when the character string is not “NSR03” (in steps ST101 to ST103 of FIG. 5).

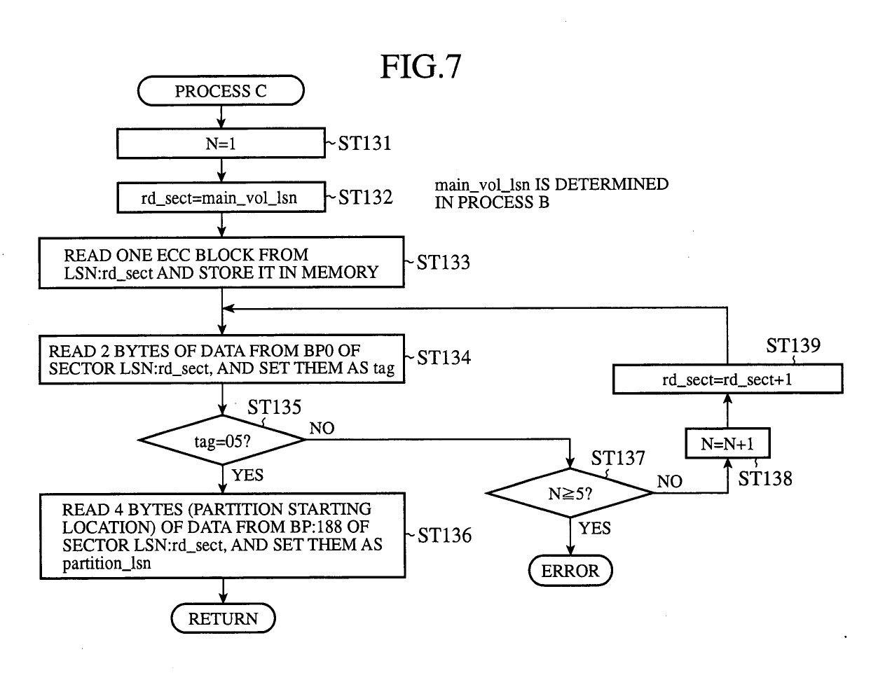

When the standard determination unit 11 recognizes that the file system conforms to the “ECMA167” standard, the header volume acquiring unit 12 carries out a process B (in step ST2) so as to acquire the logical sector number “20h” of the header volume descriptor from the anchor volume descriptor that exists at the logical sector number “100h”. In other words, the header volume acquiring unit 12 reads 2 bytes of data from the head of the anchor volume descriptor and checks to see whether the data agrees with a tag identifier “02” (in steps ST111 to ST113 of FIG. 6). When the data does not agree with the tag identifier “02”, the standard determination unit 11 assumes that an error has occurred and ends the process B. In contrast, when the data agrees with the tag identifier “02”, the standard determination unit 11 acquires the logical sector number of the header volume descriptor from a main volume descriptor sequence extent that is placed 20 bytes behind the head of the anchor volume descriptor (in steps ST114 to ST116). The standard determination unit 11 then reads 2 bytes of data from the logical sector number of the header volume descriptor and checks to see whether the data agrees with either of tag identifiers “01”, “04”, “05”, “06” and “71” (in steps ST117 and ST118).

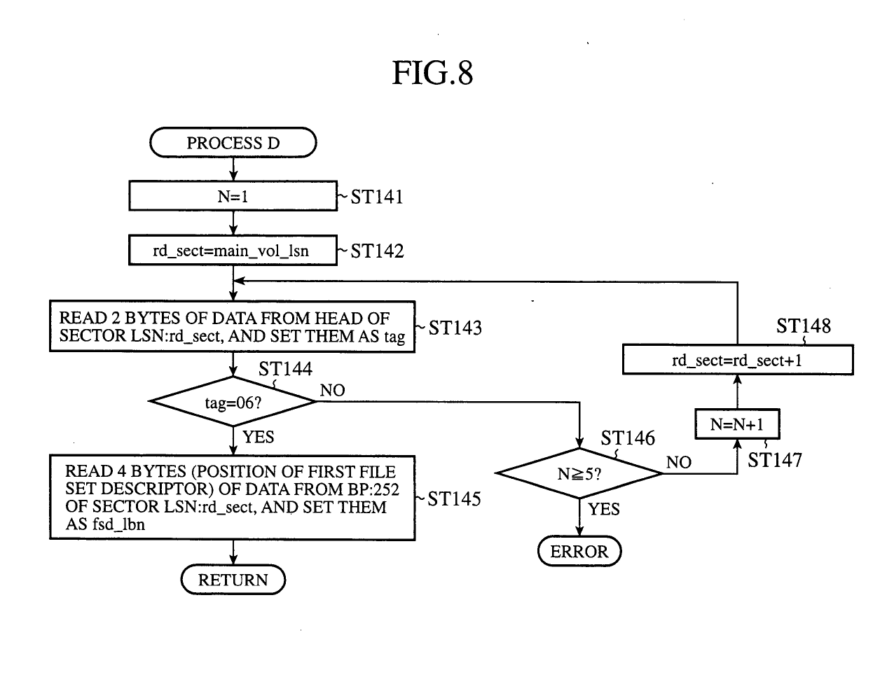

When the data agrees with either of those tag identifiers, the standard determination unit 11 ends the process B. In contrast, when the data agrees with neither of those tag identifiers, the standard determination unit 11 acquires the logical sector number of the header volume descriptor from a reserve volume descriptor sequence extent that is placed 28 bytes behind the head of the anchor volume descriptor (in steps ST119 to ST121). The standard determination unit 11 then reads 2 bytes of data from the logical sector number of the header volume descriptor and checks to see whether the data agrees with either of tag identifiers “01”, “04”, “05”, “06” and “71” (in steps ST122 and ST123). When the data agrees with either of those tag identifiers, the standard determination unit 11 ends the process B. In contrast, when the data agrees with neither of those tag identifiers, the standard determination unit 11 assumes that an error has occurred and ends the process B. When the header volume acquiring unit 12 acquires the logical sector number “20h” of the header volume descriptor, the partition acquiring unit 13 carries out a process C (in step ST3) so as to start replaying the disk from the logical sector number “20h”, and then searches for the partition descriptor so as to acquire the logical sector number “2180h” indicating the starting location of the partition from the partition descriptor. In other words, the partition acquiring unit 13 starts replaying the disk from the logical sector number “20h” so as to read data, and then checks to see whether the data agrees with a tag identifier “05” (in steps ST131 to ST135 of FIG. 7). When the data does not agree with the tag identifier “05”, the partition acquiring unit 13 reads data by incrementing the logical sector number by only 1 and repeatedly carries out the same process (in steps ST137 to ST139). However, when the data still does not agree with the tag identifier “05” even after performing the above-mentioned process five times, the partition acquiring unit 13 ends the process C. In contrast, when the data agrees with the tag identifier, the partition acquiring unit 13 recognizes that the read descriptor is a partition descriptor and acquires 4 bytes of data (i.e., the logical sector number “2180h” indicating the starting location of the partition) that is placed 188 bytes behind the head of a sector specified by the lowmost logical sector number (in step ST136).

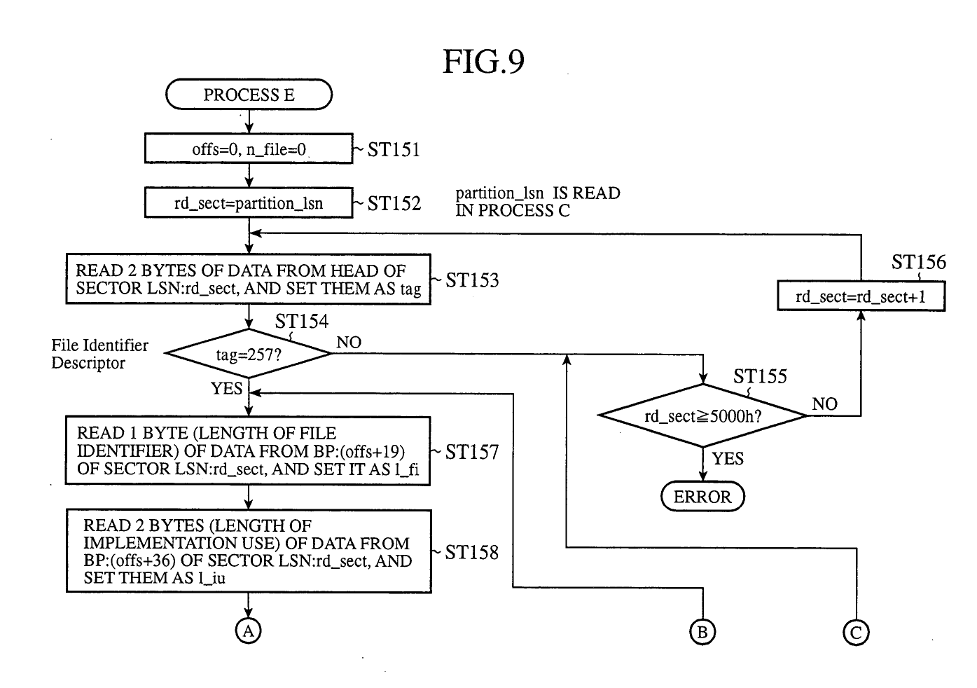

The file entry acquiring unit 14 carries out a process D (in step ST4) so as to start replaying the disk from the logical sector number “20h” indicating the starting location of the partition, and then searches for the logical volume descriptor so as to acquire the logical block number “90h” of the first file set descriptor from the logical volume descriptor. In other words, the file entry acquiring unit 14 starts replaying the disk from the logical sector number “20h” so as to read data, and checks to see whether the data agrees with a tag identifier “06” (in steps ST141 to ST144 of FIG. 8). When the data does not agree with the tag identifier “06”, the file entry acquiring unit 14 reads data by incrementing the logical sector number by only 1 and repeatedly carries out the same process (in steps ST146 to ST148). However, when the data still does not agree with the tag identifier “06” even after performing the above-mentioned process five times, the file entry acquiring unit 14 ends the process D. In contrast, when the data agrees with the tag identifier, the file entry acquiring unit 14 recognizes that the read descriptor is a logical volume descriptor and acquires 4 bytes of data (i.e., the logical block number “90h” of the first file set descriptor) that is placed 252 bytes behind the head of a sector specified by the lowmost logical sector number (in step ST145).

When there is a loss in the data about the logical volume descriptor, because the file entry acquiring unit 14 cannot acquire the logical block number “90h” of the first file set descriptor even if the file entry acquiring unit 14 searches for the logical volume descriptor as previously mentioned, the file entry acquiring unit 14 cannot perform processes F to I at the normal operating time. Therefore, when there is a loss in the data about the logical volume descriptor (in step ST5), the file entry acquiring unit 14 carries out a process E (in step ST6) so as to start replaying the disk from the logical sector number “2180h” acquired by the partition acquiring unit 13 and then acquires the logical block numbers “A8h” and “ABh” of the file entries (i.e., “VR_MANGAR.IFO” and “VR_MOVIE.VRO” file entries).

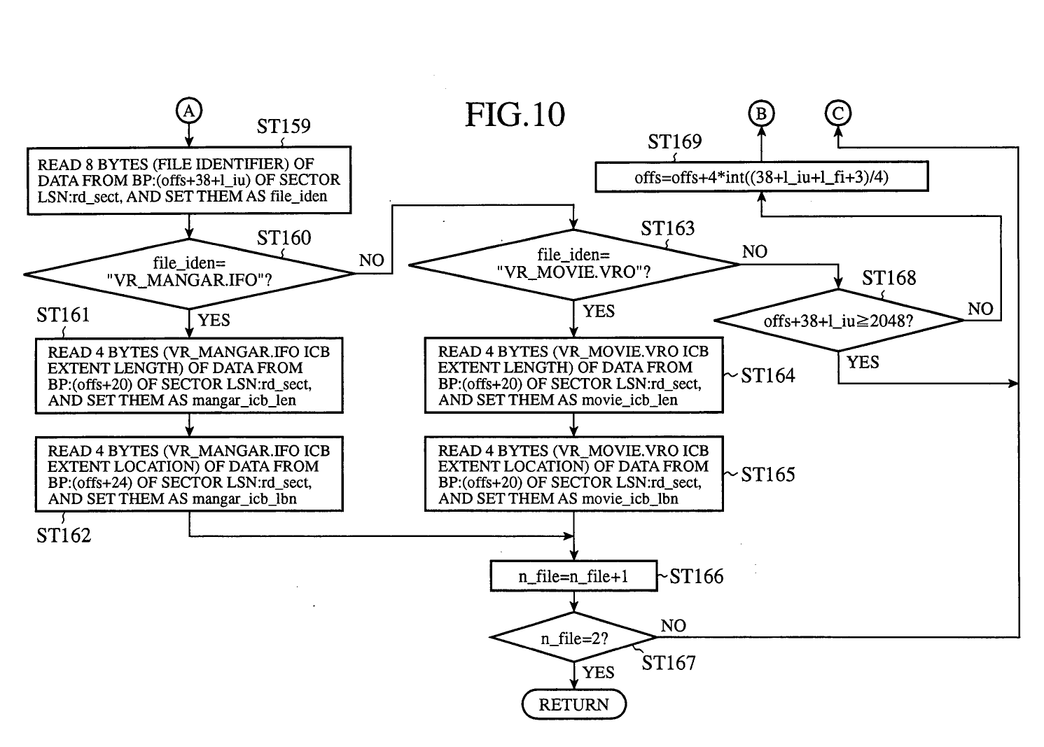

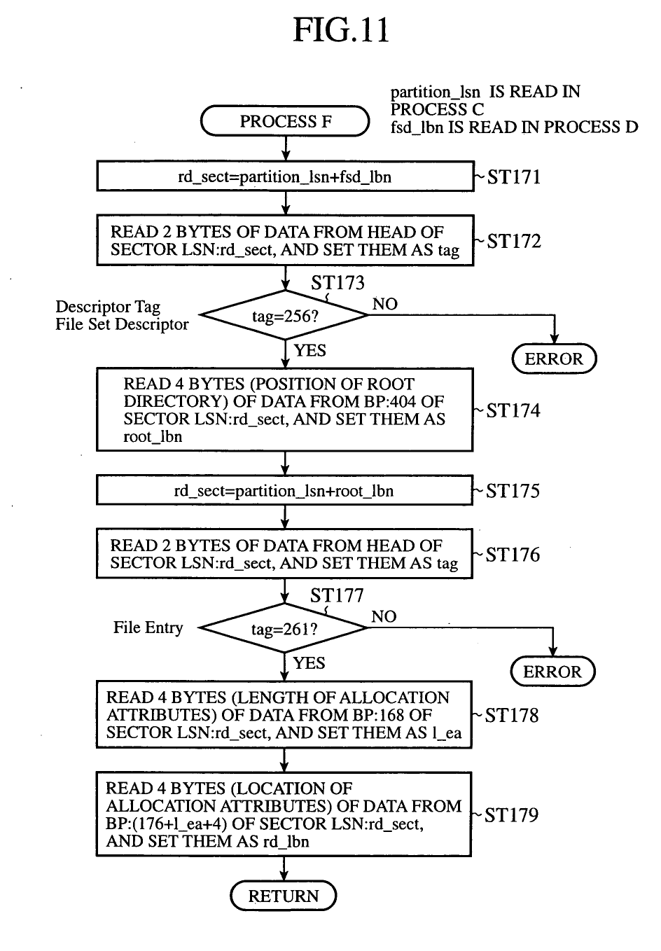

In other words, the file entry acquiring unit 14 searches for a tag identifier “257” by repeating the reproduction of the disk from the logical sector number “2180h” indicating the starting location of the partition to a logical sector number “5000h” (in steps ST151 to ST156 of FIG. 9). When then finding out the tag identifier “257”, the file entry acquiring unit 14 acquires the logical block numbers “A8h” and “ABh” of the file entries (i.e., “VR_MANGAR.IFO” and “VR_MOVIE.VRO” file entries) by searching for the file identifiers “VR_MANGAR.IFO” and “VR_MOVIE.VRO” (in steps ST157 to ST169 of FIGS. 9 and 10). On the other hand, when there is no loss in the data about the logical volume descriptor, the file entry acquiring unit 14 performs the processes F to I at the normal operating time, as mentioned above. Because the file entry acquiring unit 14 acquires the logical block number “90h” of the first file set descriptor, the file entry acquiring unit 14 carries out the process F (in step ST7) so as to acquire the logical block number “A0h” of the file entry of the root directory from the first file set descriptor. In other words, after starting replaying the disk from (the logical block number “90h” of the first file set descriptor+the logical sector number “2180h” indicating the starting location of the partition), and recognizes that the tag identifier is “256”, the file entry acquiring unit 14 acquires the logical block number “A0h” of the file entry of the root directory (in steps ST171 to ST174 of FIG. 11).

The file entry acquiring unit 14 then acquires a logical block number “A1h” of a file identity fire descriptor from the file entry of the root directory. In other words, after starting replaying the disk from (the logical block number “A0h” of the file entry of the root directory+the logical sector number “2180h” indicating the starting location of the partition), and recognizing that the tag identifier is “261”, the file entry acquiring unit 14 acquires the logical block number “A1h” of the file identity fire descriptor (in steps ST175 to ST179).

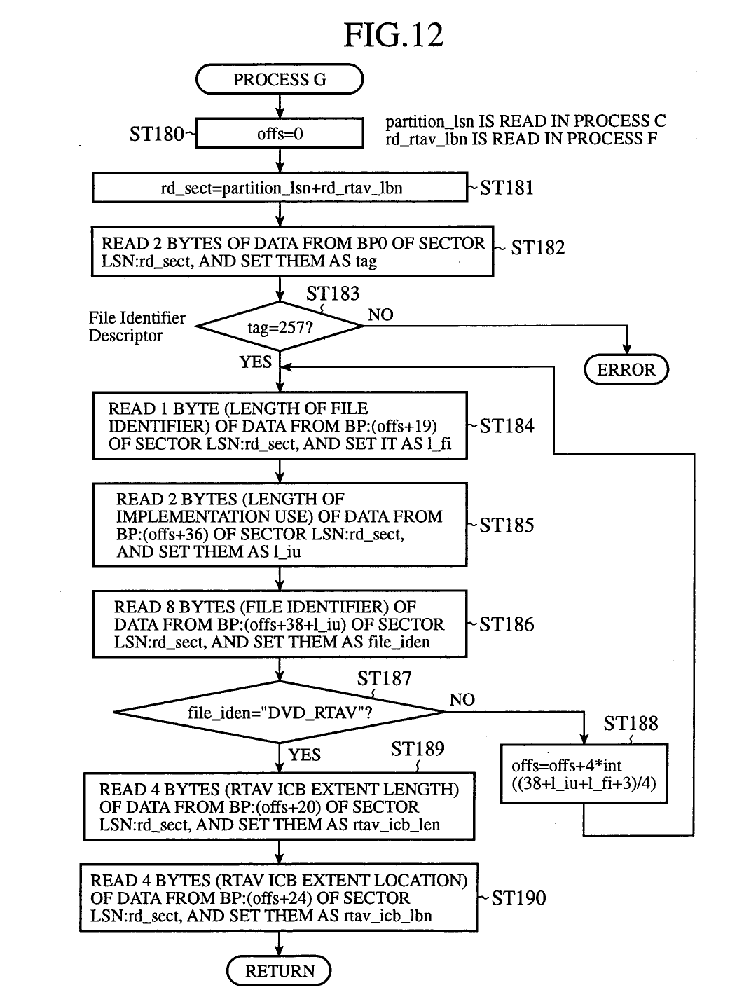

The file entry acquiring unit 14 carries out a process G (in step ST8) so as to acquire the logical block number “A5h” of a DVD_RTAV file entry from the file identity fire descriptor. In other words, after starting replaying the disk from (the logical block number “A1h” of the file identity fire descriptor+the logical sector number “2180h” indicating the starting location of the partition), and recognizing that the tag identifier is “257”, the file entry acquiring unit 14 acquires the logical block number “A5h” of the DVD_RTAV file entry (in steps ST180 to ST190 of FIG. 12).

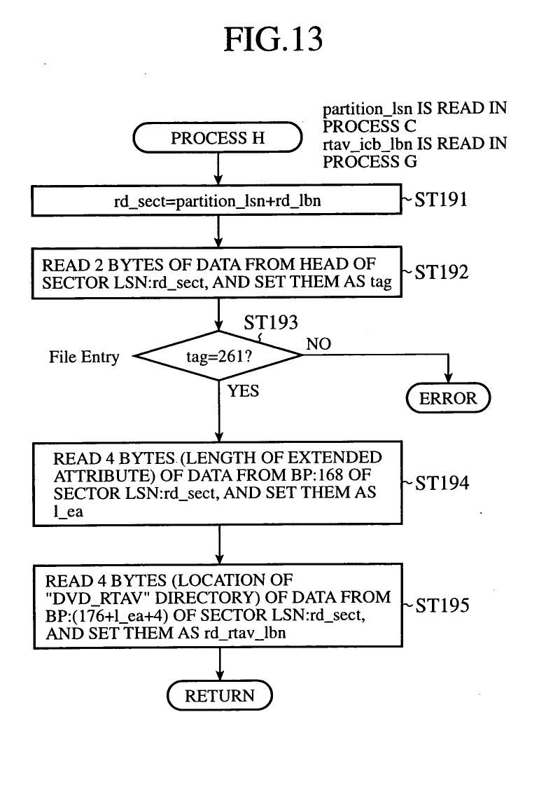

The file entry acquiring unit 14 carries out a process H (in step ST9) so as to acquire the logical block number “A6h” of a DVD_RTAV directory from the DVD_RTAV file entry. In other words, after starting replaying the disk from (the logical block number “A5h” of the DVD_RTAV file entry+the logical sector number “2180h” indicating the starting location of the partition), and recognizing that the tag identifier is “261”, the file entry acquiring unit 14 acquires the logical block number “A6h” of the DVD_RTAV directory (in steps ST191 to ST195 of FIG. 13).

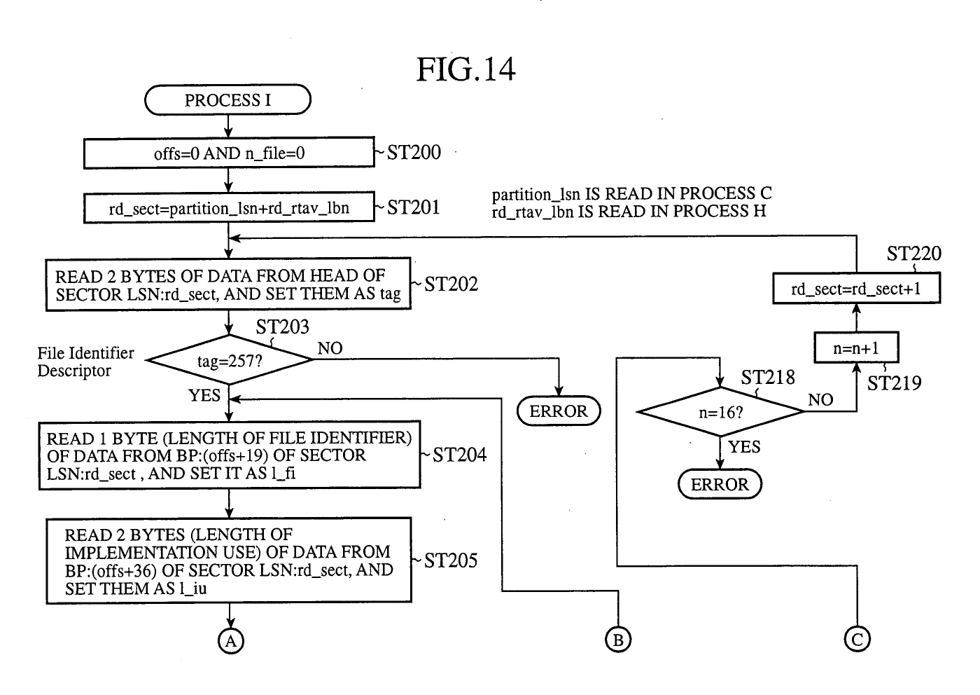

The file entry acquiring unit 14 carries out a process I (in step ST10) so as to acquire the logical block numbers “A8h” and “ABh” of the file entries (i.e., “VR_MANGAR.IFO” and “VR_MOVIE.VRO” file entries) from the DVD_RTAV directory. In other words, the file entry acquiring unit 14 acquires the logical block numbers “A8h” and “ABh” of the file entries (i.e., “VR_MANGAR.IFO” and “VR_MOVIE.VRO” file entries) by starting replaying the disk from (the logical block number “A6h” of the DVD_RTAV directory+the logical sector number “2180h” indicating the starting location of the partition), and searching for the tag identifier “257” (in steps ST200 to ST220 of FIGS. 14 and 15).

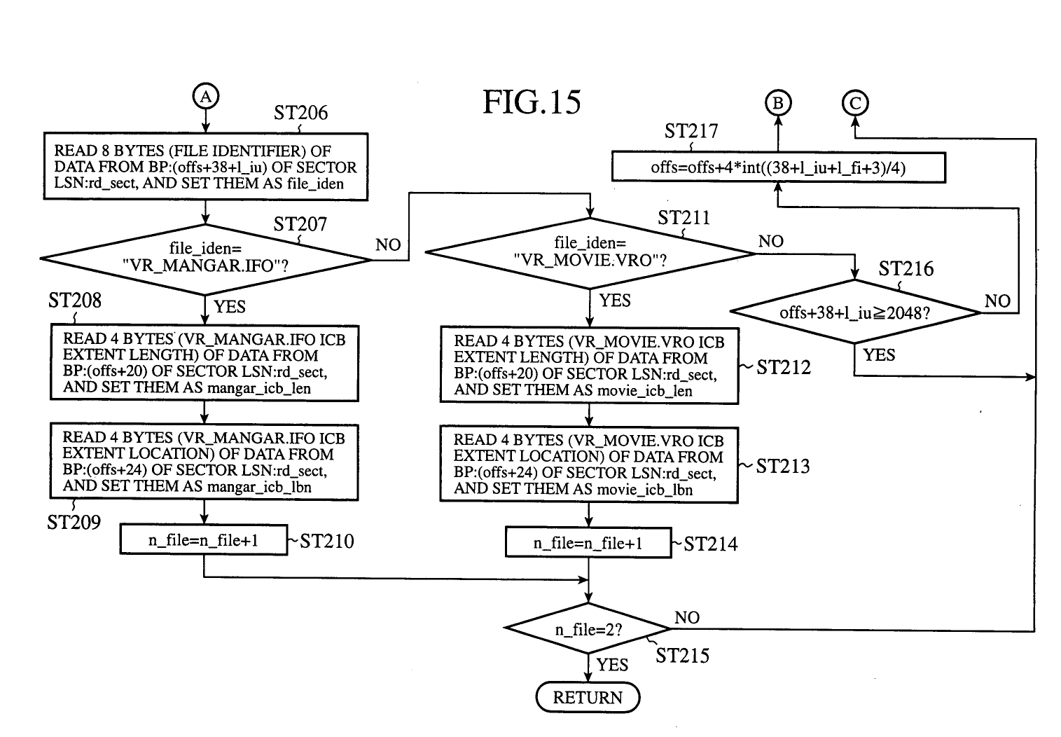

When the file entry acquiring unit 14 acquires the logical block number “A8h” of the “VR_MANGAR.IFO” file entry, as previously mentioned, the file position identifying unit 15 carries out a process J (in step ST11) so as to acquire the logical block number “600h” indicating the position of a “VR_MANGAR.IFO” file and the length of the file from the file entry that exists at the logical block number “A8h”. In other words, after starting replaying the disk from (the logical block number “A8h” of the “VR_MANGAR.IFO” file entry+the logical sector number “2180h” indicating the starting location of the partition), and recognizing that the tag identifier is “261”, the file position identifying unit 15 acquires the logical block number “600h” indicating the position of the file and the length of the file (in steps ST221 to ST225 of FIG. 16).

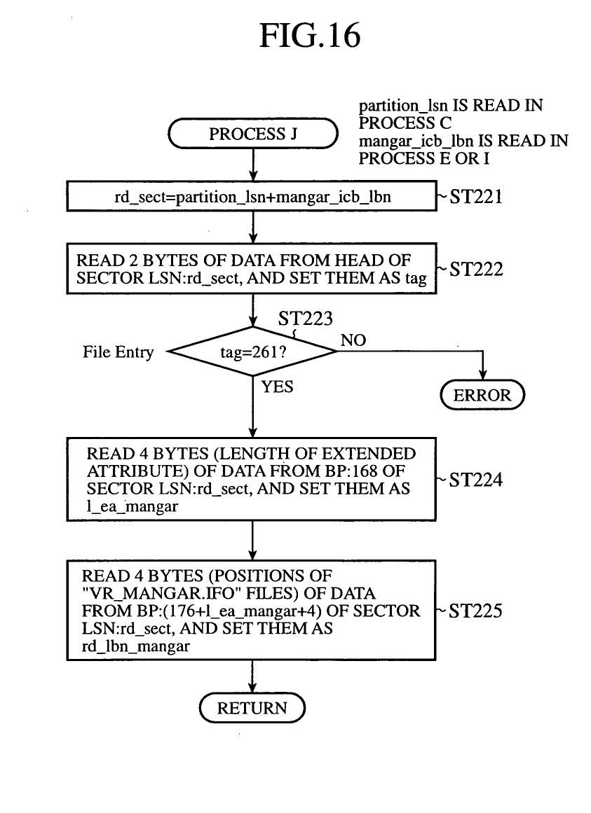

Furthermore, the file position identifying unit 15 carries out a process K (in step ST12) so as to acquire a logical block number “11D2h” indicating the position of a “VR_MOVIE.VRO” file and an extent length from the file entry that exists at the logical block number “ABh” of the “VR_MOVIE.VRO” file entry. In other words, after starting replaying the disk from (the logical block number “ABh” of the “VR_MOVIE.VRO” file entry+the logical sector number “2180h” indicating the starting location of the partition), and recognizing that the tag identifier is “261”, the file position identifying unit 15 acquires the logical block number “11D2h” indicating the position of the file and the extent length (in steps ST231 to ST242 of FIG. 17).

The file position identifying unit 15 then adds the logical block number “600h” indicating the position of the “VR_MANGAR.IFO” file to the logical sector number “2180h” indicating the starting location of the partition so as to acquire a logical sector number “2780h” indicating the position of the “VR_MANGAR.IFO” file. The file position identifying unit 15 then adds the logical block number “11D2h” indicating the position of the “VR_MOVIE.VRO” file to the logical sector number “2180h” indicating the starting location of the partition so as to acquire a logical sector number “3352h” indicating the position of the “VR_MOVIE.VRO” file.

As can be seen from the above description, in accordance with this embodiment 1, when the logical block number “90h” of the first file set descriptor is not acquired from the logical volume descriptor due to a loss in the data about the logical volume descriptor, the data reproducing apparatus starts replaying the disk from the logical sector number “2180h” indicating the starting location of the partition, which is acquired by the partition acquiring unit 13, and searches for given file entries (i.e., “VR_MANGAR.IFO” and “VR_MOVIE.VRO” file entries) so as to acquire the logical block numbers “A8h” and “ABh” of the file entries. Therefore, the data reproducing apparatus can identify the positions of files without changing the standard to which the file system of the disk conforms even if there occurs a data loss in the logical volume descriptor.

Furthermore, in accordance with this embodiment 1, the file entry acquiring unit 14 checks to see whether data acquired every time when the disk is replayed agrees with a tag identifier “257”, and, when determining that the data agrees with the tag identifier “257”, recognizes that the region specified by the data is a region in which the logical block numbers of the file entries are recorded. Therefore, the data reproducing apparatus can identify the region in which the logical block numbers of the file entries are recorded without causing a complication of the structure thereof.

### Embodiment 2

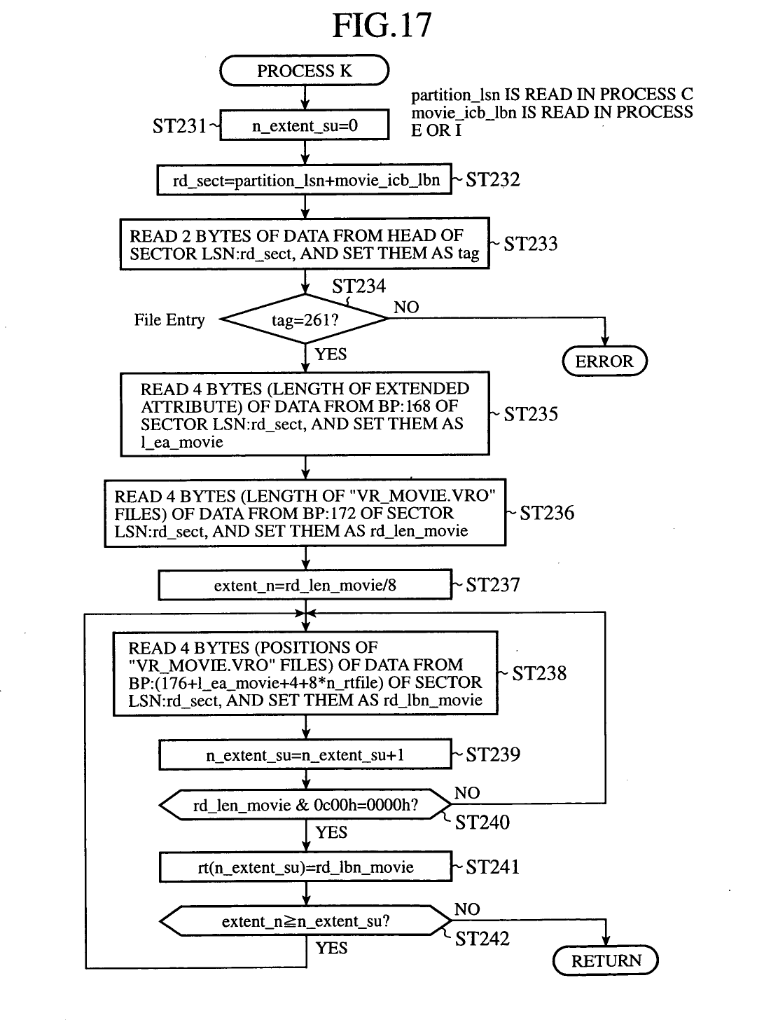

FIG. 18 is a block diagram showing a processing function of a control unit 10 of a data reproducing apparatus in accordance with this embodiment 2. The same reference numerals as shown in FIG. 2 denote the same components as those of the data reproducing apparatus in accordance with embodiment 1, or like components, and therefore the explanation of those components will be omitted hereafter.

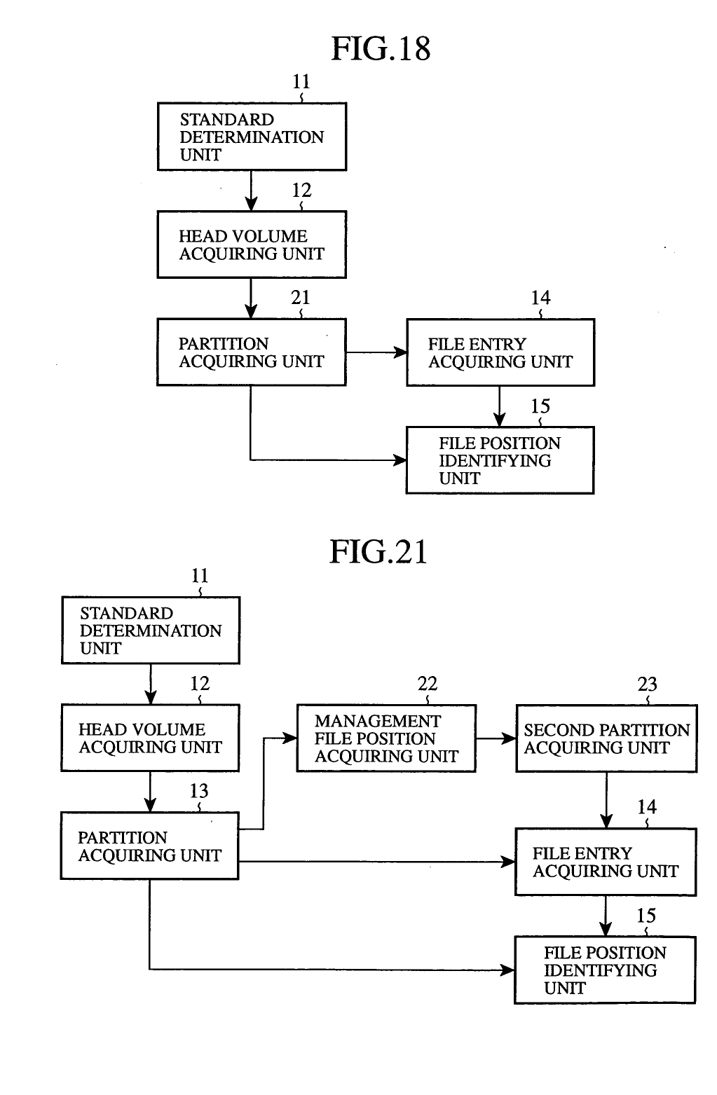

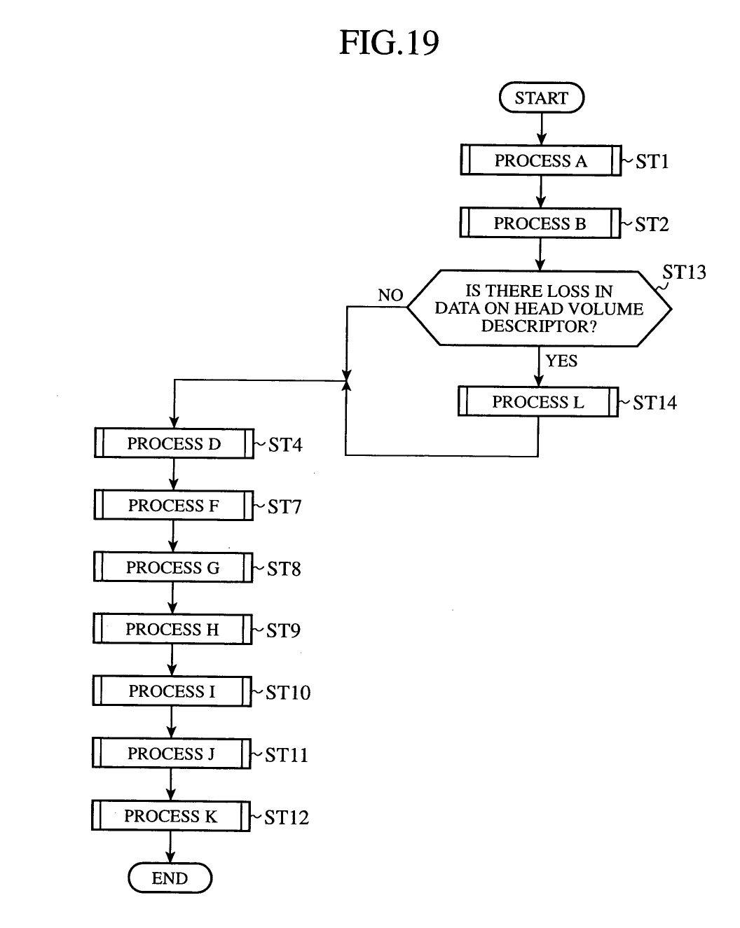

Like the partition acquiring unit 13 in accordance with above-mentioned embodiment 1, a partition acquiring unit 21 can acquire a logical sector number indicating a starting location of a partition of a disk. When a header volume acquiring unit 12 cannot acquire the logical sector number “20h” of a header volume descriptor because there is a loss in the data about the header volume descriptor, the partition acquiring unit 21 reproduces data recorded on the disk specified by the logical sector numbers “20h” to “30h” and searches for a tag identifier indicating a partition descriptor so as to acquire a logical sector number “2180h” indicating the starting location of the partition. The partition acquiring unit 21 constitutes a partition acquiring means. In accordance with this embodiment 2, a file entry acquiring unit 14 constitutes a root directory acquiring means. FIGS. 19 and 20 are flow charts showing processes performed by the control unit 10 of the data reproducing apparatus in accordance with this embodiment 2.

Next, a description will be made as to the operation of the control unit 10. A standard determination unit 11 and the header volume acquiring unit 12 carry out the same processes as done by those of above-mentioned embodiment 1. When the header volume acquiring unit 12 cannot recognize tag identifiers “01”, “04”, “05”, “06”, and “71” because there is a loss in the data about the header volume descriptor, for example, the header volume acquiring unit 12 cannot acquire the logical sector number “20h” of the header volume descriptor.

When the header volume acquiring unit 12 cannot acquire the logical sector number “20h” of the header volume descriptor (in step ST13), the partition acquiring unit 21 carries out a process L (in step ST14) so as to reproduce data recorded on the disk specified by the logical sector numbers “20h” to “30h”, and then searches for a tag identifier indicating a partition descriptor so as to acquire the logical sector number “2180h” indicating the starting location of the partition. In other words, when acquiring the 2 bytes of data by replaying the disk, the partition acquiring unit 21 checks to see whether the data agrees with a tag identifier “05”, and, when determining that the data agrees with the tag identifier “05”, recognizes that the descriptor is a partition descriptor. The partition acquiring unit 21 then acquires 4 bytes of data (i.e., the logical sector number “2180h” indicating the starting location of the partition) that is placed 188 bytes behind the logical sector number “20h” (in steps ST251 to ST258 of FIG. 20). The partition acquiring unit 21 further acquires 4 bytes of data that is placed 192 bytes behind the logical sector number “20h” by assuming that the data indicates the length of the partition (in step ST259). After that, the data reproducing apparatus in accordance with embodiment 2 operates in the same manner that that in accordance with above-mentioned embodiment 1, and therefore the explanation will be omitted hereafter.

As can be seen from the above description, in accordance with this embodiment 2, when the header volume acquiring unit 12 cannot acquire the logical sector number “20h” of the header volume descriptor because there is a loss in the data about the header volume descriptor, the partition acquiring unit 21 reproduces data recorded on the disk specified by the logical sector numbers “20h” to “30h” and searches for a tag identifier indicating a partition descriptor so as to acquire the logical sector number “2180h” indicating the starting location of the partition. Therefore, the data reproducing apparatus can identify the position of a file without changing the standard to which the file system of the disk conforms even if there occurs a data loss in the header volume descriptor.

Furthermore, in accordance with this embodiment 2, the partition acquiring unit 21 checks to see whether data acquired every time when the disk is replayed agrees with a tag identifier “05”, and, when determining that the data agrees with the tag identifier “05”, recognizes that a region in which the starting location of the partition is recorded exists in a predetermined area of the descriptor. Therefore, the data reproducing apparatus can identify the region in which the logical sector number indicating the starting location of the partition is recorded without causing a complication of the structure thereof.

### Embodiment 3

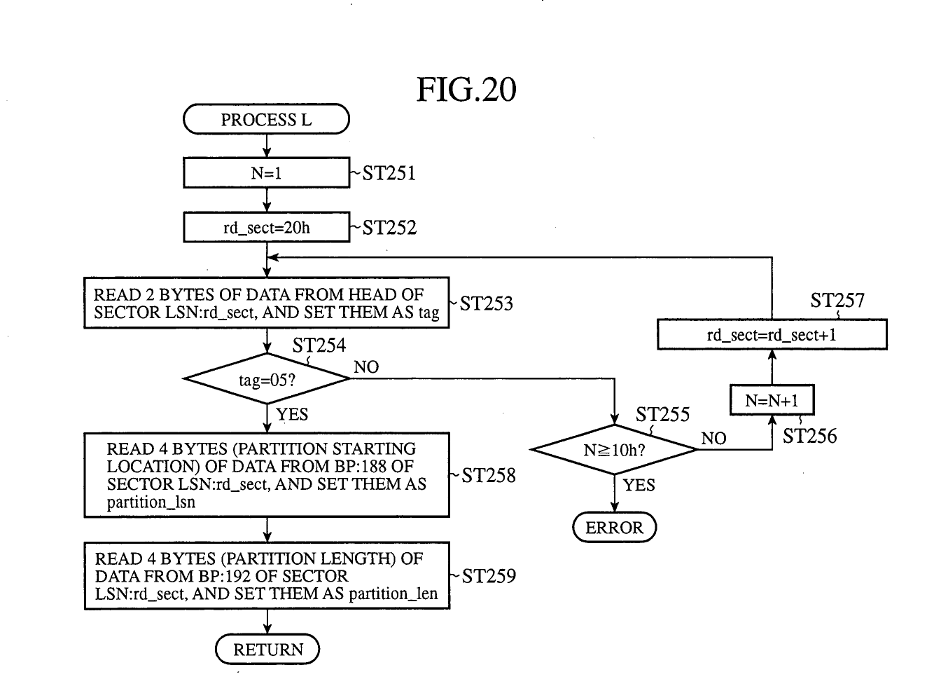

FIG. 21 is a block diagram showing a processing function of a control unit 10 of a data reproducing apparatus in accordance with this embodiment 3. The same reference numerals as shown in FIG. 2 denote the same components as those of the data reproducing apparatus in accordance with embodiment 1, or like components, and therefore the explanation of those components will be omitted hereafter.

When a partition acquiring unit 13 cannot acquire a logical sector number “2180h” indicating a starting location of a partition of a disk, a management file position acquiring unit 22 starts replaying the disk from a logical sector number “2000h” and searches for a character string “DVD_RTR_VMG0” so as to acquire a physical address indicating a location where the character string exists, and then calculates a logical sector number corresponding to the physical address. The management file position acquiring unit 22 constitutes a management file position acquiring means.

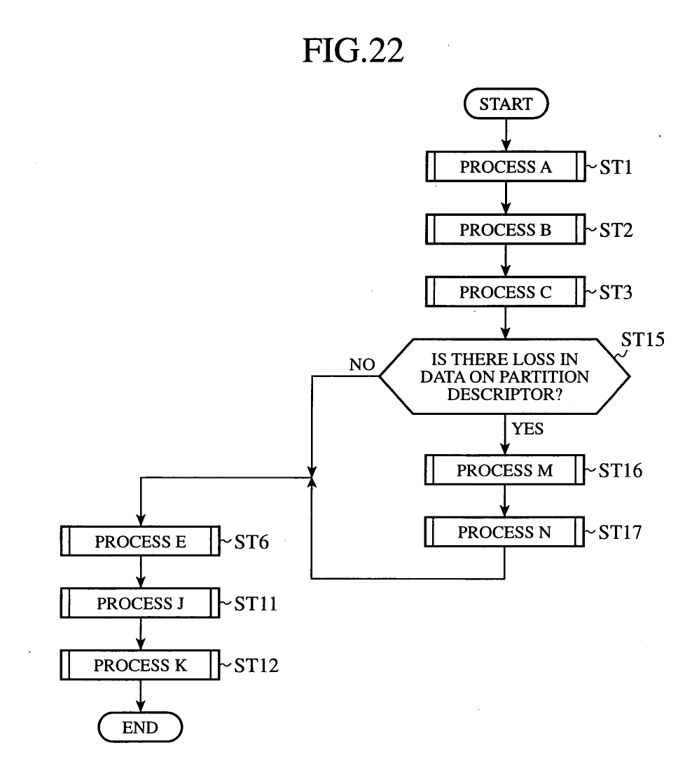

A second partition acquiring unit 23 starts replaying the disk from the logical sector number “2000h” and then reproduces the file entry of a management file by searching through tag identifiers indicating file entries for the file entry of the management file so as to acquire a logical block number indicating the position of the management file. The second partition acquiring unit 23 calculates the logical sector number “2180h” indicating the starting location of the partition from the acquired logical block number and the logical sector number calculated by the management file position acquiring unit 22. The second partition acquiring unit 23 constitutes a partition acquiring means. FIGS. 22 to 24 are flow charts showing processes performed by the control unit 10 of the data reproducing apparatus in accordance with this embodiment 3.

Next, a description will be made as to the operation of the control unit 10. A standard determination unit 11, a header volume acquiring unit 12, and a partition acquiring unit 13 carry out the same processes as performed by those of above-mentioned embodiment 1. When the partition acquiring unit 13 cannot recognize a tag identifier “05” because there is a loss in data about a partition descriptor, for example, the partition acquiring unit 13 cannot acquire the logical sector number “2180h” indicating the starting location of the partition.

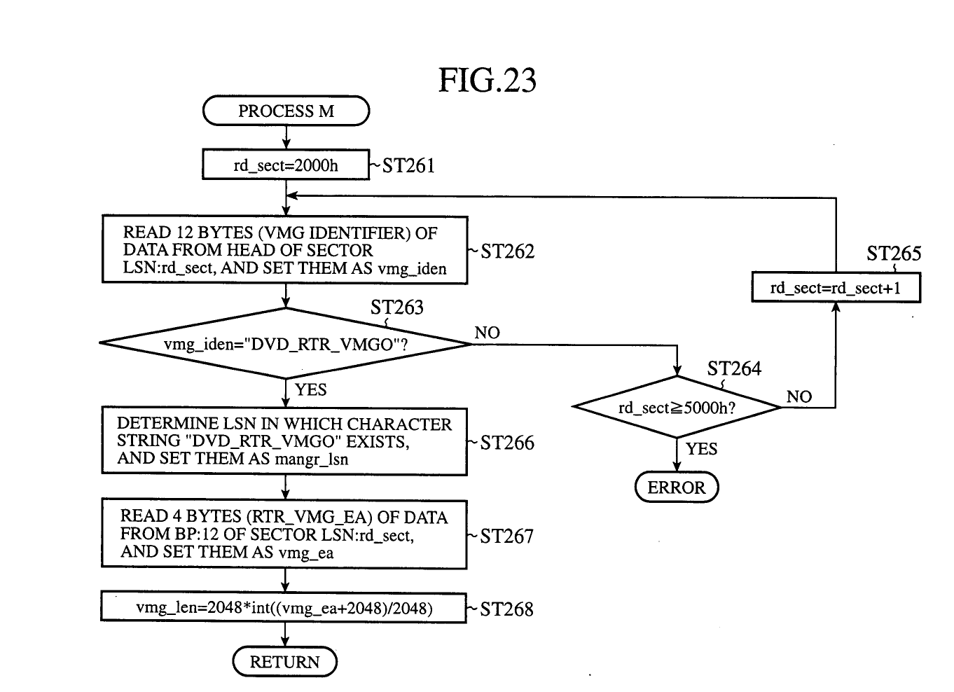

When the partition acquiring unit 13 cannot acquire the logical sector number indicating the starting location of the partition (in step ST15), the management file position acquiring unit 22 carries out a process M (in step ST16) so as to reproduce data recorded on the disk specified by the logical sector numbers “2000h” to “5000h”, and then searches for a character string “DVD_RTR_VMG0” so as to acquire a physical address “32229h” indicating a location on the disk where the character string exists. In other words, the management file position acquiring unit 22 replays the disk so as to acquire 12 bytes of data from the head of the logical sector and checks to see whether the data agrees with the character string “DVD_RTR_VMG0” (in steps ST261 to ST265 of FIG. 23). When the data agrees with the character string “DVD_RTR_VMG0”, the management file position acquiring unit 22 acquires the physical address “32229h” indicating a location on the disk where the character string exists and determines a logical sector number “2229h” corresponding to the physical address “32229h” (in step ST266) and further determines the length of the management file (in steps ST267 and ST268).

The second partition acquiring unit 23 carries out a process N so as to start replaying the disk from the logical sector number “2000h” (in step ST17), and then reproduces the file entry of the management file by searching through tag identifier indicating file entries for the file entry of the management file. The second partition acquiring unit 23 then acquires a logical block number “A9h” indicating the position of the management file. The second partition acquiring unit 23 calculates the logical sector number “2180h” indicating the starting location of the partition from the logical block number “A9h” and the logical sector number “2229h” calculated by the management file position acquiring unit 22.

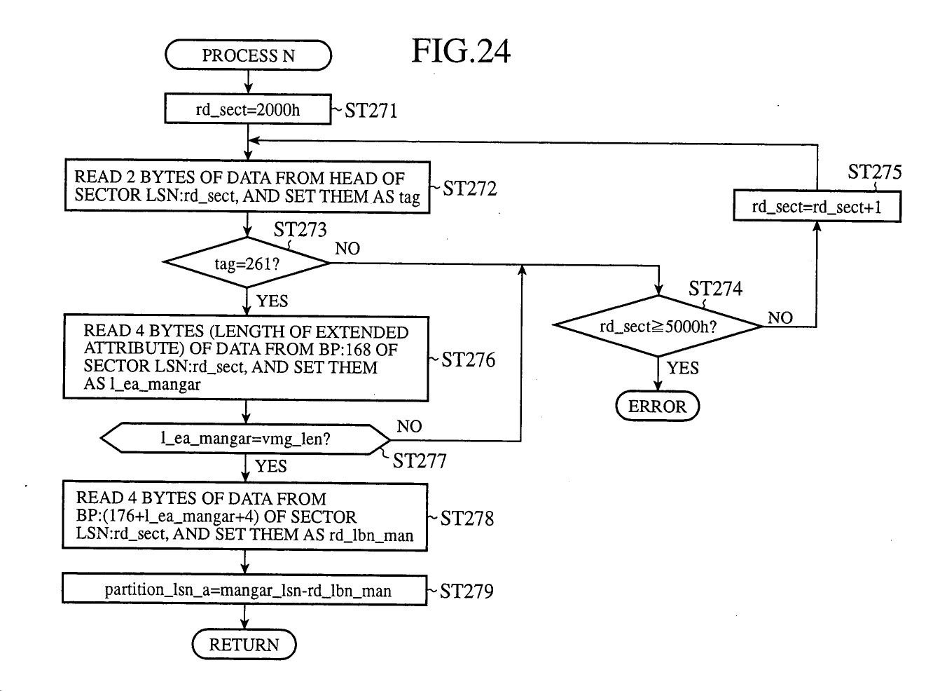

In other words, the second partition acquiring unit 23 starts replaying the disk from the logical sector number “2000h” so as to search for the tag identifier “261” of the file entry. When the tag identifier “261” exists, the second partition acquiring unit 23 acquires 4 bytes of data that is placed 168 bytes behind the head of a sector specified by the logical sector number “2000h”, and checks to see whether the data agrees with the length of the file acquired in step ST268 (in steps ST271 to ST277 of FIG. 24). When the data agrees with the length of the management file, by acquiring 4 bytes of data that is placed (176+the file length+4) bytes behind the sector head, the second partition acquiring unit 23 acquires the logical block number “A9h” indicating the position of the management file (in step ST278).

The second partition acquiring unit 23 then subtracts the logical block number “A9h” indicating the position of the management file from the logical sector number “2229h” corresponding to the physical address “32229h” of the character string “DVD_RTR_VMG0” so as to determine the logical sector number “2180h” indicating the starting location of the partition (in step ST279). After that, the data reproducing apparatus in accordance with embodiment 3 operates in the same manner that that in accordance with above-mentioned embodiment 1, and therefore the explanation will be omitted hereafter.

As can be seen from the above description, in accordance with this embodiment 3, the data reproducing apparatus acquires a logical block number “A9h” indicating the position of a management file, and calculates a logical sector number “2180h” indicating the starting location of the partition from the logical block number “A9h” and a logical sector number “2229h” calculated by the management file position acquiring unit 22. Therefore, the data reproducing apparatus can identify the position of a file without changing the standard to which the file system of the disk conforms even if there occurs a data loss in the partition descriptor.

In addition, in accordance with this embodiment 3, the data reproducing apparatus subtracts the logical block number “A9h” indicating the position of the management file from the logical sector number “2229h” corresponding to the physical address “32229h” of a character string “DVD_RTR_VMG0” so as to determine the logical sector number “2180h” indicating the starting location of the partition. Therefore, the data reproducing apparatus can determine the logical sector number “2180h” indicating the starting location of the partition without causing a complication of the structure thereof.

Many widely different embodiments of the present invention may be constructed without departing from the spirit and scope of the present invention. It should be understood that the present invention is not limited to the specific embodiments described in the specification, except as defined in the appended claims.

1. A data reproducing apparatus comprising:
a partition acquiring means for acquiring a logical sector number of a header volume descriptor from an anchor volume descriptor recorded in a predetermined logical sector, and for starting replaying a disk from the logical sector number so as to acquire a logical sector number indicating a starting location of a partition;
a file entry acquiring means for starting replaying the disk from a predetermined logical sector number so as to acquire a logical block number of a file entry; and
a file position identifying means for acquiring a logical block number indicating a position of a file from the logical block number acquired by said file entry acquiring means and from the logical sector number acquired by said partition acquiring means, and for identifying a logical sector number indicating the position of the file from the logical block number acquired thereby and from the logical sector number acquired by said partition acquiring means.

2. The data reproducing apparatus in accordance with claim 1, wherein said file entry acquiring means determines whether data that is acquired every time the disk is replayed agrees with a predetermined tag identifier, and, when determining that the data agrees with the predetermined tag identifier, recognizes that a predetermined region accompanying the data is a region in which the logical block number of the file entry is recorded.

3. A data reproducing apparatus comprising:
a partition acquiring means for starting replaying a disk from a predetermined logical sector number so as to acquire a logical sector number indicating a starting location of a partition;
a root directory acquisition mean for reading a logical block number indicating a position of a root directory, and for acquiring a logical sector number indicating the position of the root directory from the read logical block number and the logical sector number acquired by said partition acquiring means;
a file entry acquiring means for starting replaying the disk from the logical sector number acquired by said root directory acquiring means so as to acquire a logical block number of a file entry; and
a file position identifying means for acquiring a logical block number indicating a position of a file from the file entry that exists at the logical block number acquired by said file entry acquiring means, and for identifying a logical sector number indicating the position of the file from the logical block number acquired thereby and from the logical sector number acquired by said partition acquiring means and indicating the starting location of the partition.

4. The data reproducing apparatus in accordance with claim 3, wherein said partition acquiring means determines whether data that is acquired every time the disk is replayed agrees with a predetermined tag identifier, and, when determining that the data agrees with the predetermined tag identifier, recognizes that a region specified by the data is a region in which the starting location of the partition is recorded.

5. A data reproducing apparatus comprising:
a management file position acquiring means for starting replaying a disk from a predetermined logical sector number, for searching for a predetermined character string so as to acquire a physical address indicating a location where the character string exists, and for calculating a logical sector number corresponding to the physical address;
a partition acquiring means for reproducing a file entry of a management file so as to acquire a logical block number indicating a position of the management file, and for calculating a logical sector number indicating a starting location of a partition from the logical block number acquired thereby and the logical sector number calculated by said management file position acquiring means; and
a file position identifying means for identifying a logical sector number indicating a position of a file from a logical block number determined thereby by searching for a predetermined file identifier, the logical block number indicating a location from which data is to be reproduced, and from the logical sector number indicating the starting location of the partition, which is calculated by said partition acquiring means.

6. The data reproducing apparatus in accordance with claim 5, wherein said partition acquiring means determines the logical sector number indicating the starting location of the partition by subtracting the logical block number indicating the management file position from the logical sector number of the management file calculated by said management file position acquiring means.
